(19) United States
(12) Patent Application Publication
(10) Pub. No.: US 2020/0260714 A1
(43) Pub. Date: Aug. 20, 2020

(54) Angle-Adjusting Sub-Assembly and Unmanned Aerial Vehicle and Apparatus Comprising Same

(71) Applicant: Andrew Pleatman, Hong Kong (HK)

(72) Inventor: Andrew Pleatman, Hong Kong (HK)

(21) Appl. No.: 16/645,473

(22) PCT Filed: Aug. 9, 2017
(86) PCT No.: PCT/IB2017/055409

§ 371 Date: Mar. 8, 2020

Related U.S. Application Data
(60) Provisional application No. 62/467,814, filed on Mar. 6, 2017.

(51) Int. Cl. A01M 7/00; B64C 39/02; B64D 1/18; B64D 41/00; A01G 7/06; A01M 21/04

(52) U.S. Cl. CPC A01M 7/0042; B64C 39/024; B64D 1/18; B64D 41/00; A01G 7/06; A01M 7/0085; B64C 2201/12; A01M 7/0057; A01M 21/043; B64C 2201/027; B64C 2201/042; B64C 2201/108; A01M 7/006

(57) ABSTRACT

An angle-adjusting sub-assembly (6) that is part of or attached to an unmanned aerial vehicle and apparatus (1), for the targeted distribution of hazardous chemicals onto vegetation, and is comprised of: adjustable arms (7), rotary system, which adjusts the length and angle of the adjustable arms while the aerial vehicle and apparatus are airborne. An unmanned aerial vehicle and apparatus, for the targeted distribution of hazardous chemicals onto vegetation, is comprised of: the angle-adjusting sub-assembly (6), a spray assembly, a flying platform, a storage tank (2) containing pesticide, bactericide, herbicide, fungicide, or any hazardous chemical that can be sprayed on vegetation, a supporting structure (4), and a landing sub-assembly. Using of the above device decreases the runoff of toxic chemical waste to the environment, increases chemical application efficiency, and allows for the precise targeting of pests on crops.

### CROSS-REFERENCE TO RELATED APPLICATIONS

This application claims the benefit of U.S. Provisional 62/467,814 which is incorporated herein by reference.

### BACKGROUND OF THE INVENTION

Pesticide spray systems attached to unmanned aerial vehicles or drones are commonly used to eliminate crop-destroying pests in farming and other large agricultural settings. Due to imprecise targeting systems spraying hazardous chemicals across wide radii, most aerial pesticide spray systems existing in the prior art inefficiently eliminate agricultural infestations and spread toxic pesticide waste product. Exposure to this product causes injury, disease, and death.

Most existing pesticide spray systems attached to unmanned aerial vehicles are constructed with multiple nozzles mounted onto horizontal boom arms. The nozzles of these spray systems are fixed to be vertical to the ground. This causes imprecise targeting of crops, allowing agricultural infestations to decrease produce yields and exposing nearby farmworkers to toxic pesticide waste product.

A number of advanced, unmanned aerial drones have been developed in recent years for non-agricultural purposes. Leading drone producers, such as DJI and 3D Robotics, produce unmanned aerial drones primarily for security markets. In recent years, however, drone production has expanded into new markets, such as aerial mapping and construction insurance. This expansion, was induced, in part, by the United States Federal Aviation Administration, liberalizing unmanned drone regulations in 2016.

Despite these technological advances and deregulation activities, due to imprecise targeting spray systems, pesticide-related health problems continue to adversely affect the application of unmanned aerial drones in agricultural settings.

### SUMMARY OF THE INVENTION AND DESCRIPTION OF THE DRAWINGS

This disclosure is comprised of an angle adjusting sub-assembly that is accompanied by a system and device attached to a flying drone apparatus, for the targeted spraying of hazardous chemicals, such as pesticide, herbicide, bactericide, or fungicide, onto vegetation, in a manner that optimizes spray coverage while minimizing chemical waste, in agricultural settings. This embodiment of the disclosure includes an angle-adjusting sub-assembly and a separate spray assembly. An extra landing stabilization structure may also be included. The angle-adjusting sub-assembly enables the spray structure to fit different crop patterns to optimize chemical application and precise targeting of pests. The separate spray assembly enables flexible adjustment of spray parts, including nozzles and chemical tubes. The landing stabilization structure ensures the manually adjustable angle adjustment device can descend from air to ground without harming any of its critical parts. Using this full embodiment of the disclosure decreases the runoff of toxic chemical waste to the environment, and allows for the precise targeting of pests on crops.

FIG. 1 diagrams the full embodiment of the disclosure. Within the Figure, the number “1” marks the unmanned aerial vehicle apparatus, which contains a flying platform operated through batteries and propellers. The number “2” marks the storage tank, which may contain pesticide, herbicide, bactericide, fungicide, or any hazardous chemical that can be sprayed on vegetation, and which is attached to the flying platform. These tanks are common in the prior art, and the present disclosure may use different tank sizes and types, depending on the user's irrigation and pesticide needs. In certain embodiments of the present disclosure, tanks may be comprised of plastic, polyethylene, or aluminum allow, and may hold between five to thirty liters of hazardous chemical in volume. The number “3” marks an electrically driven spray pump that transfers the chemical from the storage tank to the nozzles of the spray assembly for distribution. The number “4” marks the supporting structure holding the flying platform, the storage tank, and the pump when the flying vehicle lands. This supporting structure is well-described in the prior art and may be composed of different metal alloys.

The number “5” marks a fixed arm protruding from the flying apparatus's supporting structure. It may be composed of any composite material, polymeric material or light metal such as carbon fiber, glass fiber, or aluminum alloy. In the disclosure's preferred embodiment, the fixed arm is approximately sixty (60) centimeters in length but can be changed to other sets of lengths such as three hundred (300) centimeters to better fit the plant shapes. The fixed arm stabilizes both the supporting structure of the flying apparatus and the adjustable arms marked with number “7.” The present disclosure may contain any number of adjustable arms, but in its preferred embodiment, it contains two adjustable arms that can be changed into different sets of length such as between 60 to 300 centimeters and are composed of any composite material or light metal such as carbon fiber, glass fiber, or an aluminum alloy. The number “6” marked next to each adjustable arm, indicates the angle-adjusting sub-assembly that is a core component of every embodiment of the disclosure. Containing chains and hinges that may be controlled manually, electronically, hydraulically or through applied air pressure, the sub-assembly can rotate the adjustable arm between the horizontal position and 120 degrees downward from outside to inside from the horizontal position. In its preferred embodiment, the sub-assembly is controlled with electric motors and does not contain chains and hinges. The sub-assembly with chains and hinges is described in further detail in FIGS. 3a and 3b. The sub-assembly without chains and hinges is described in further detail in FIGS. 5 and 7.

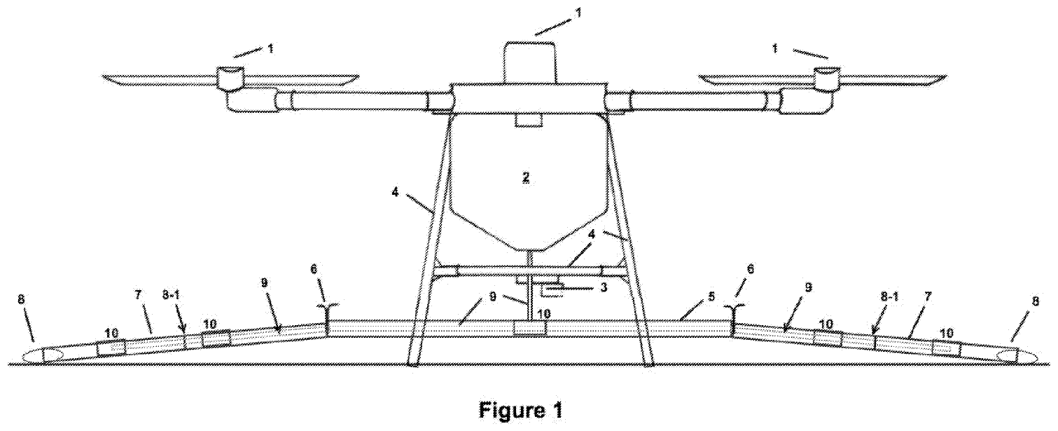

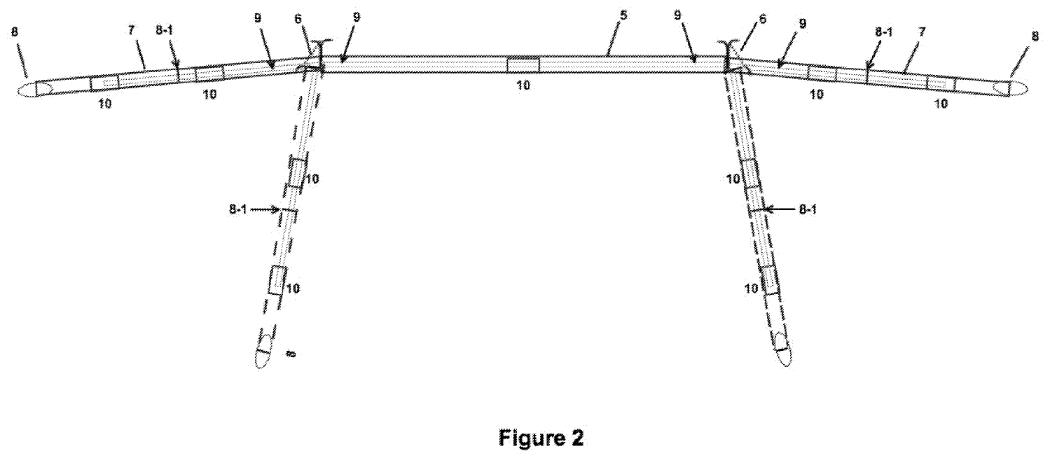

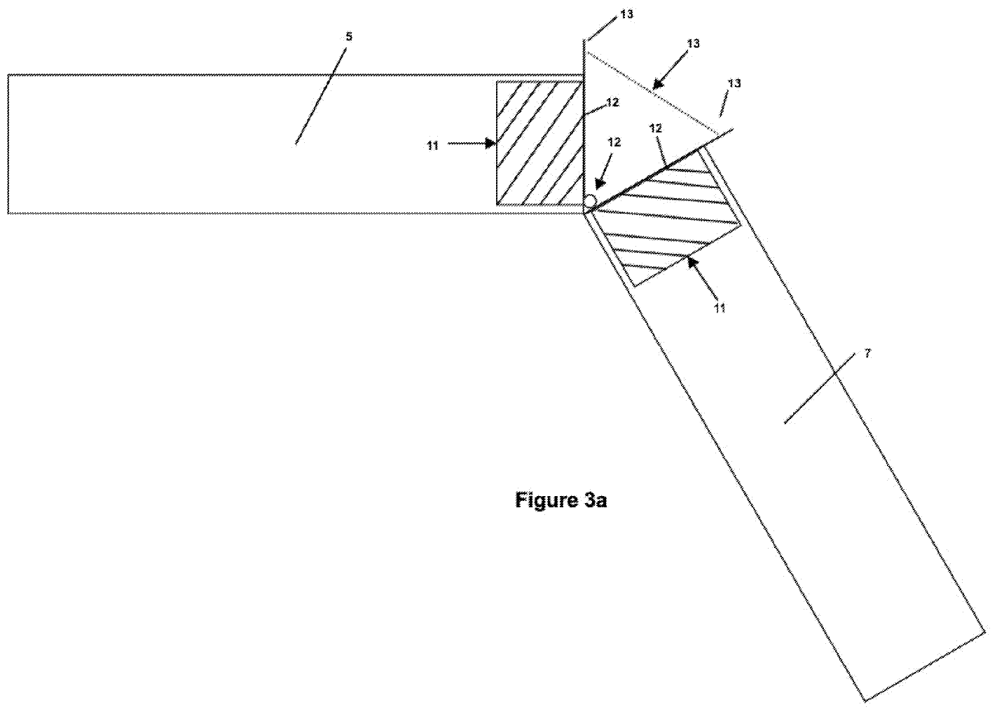

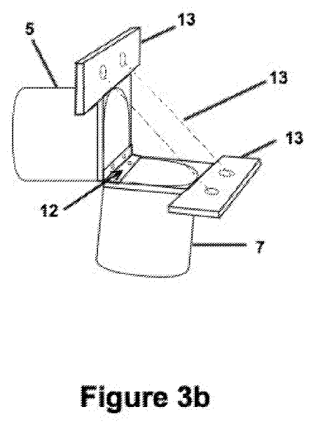

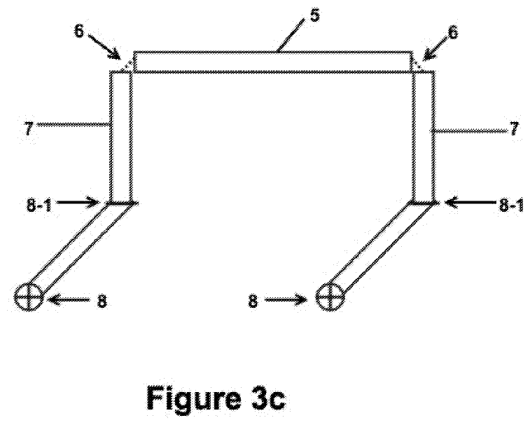

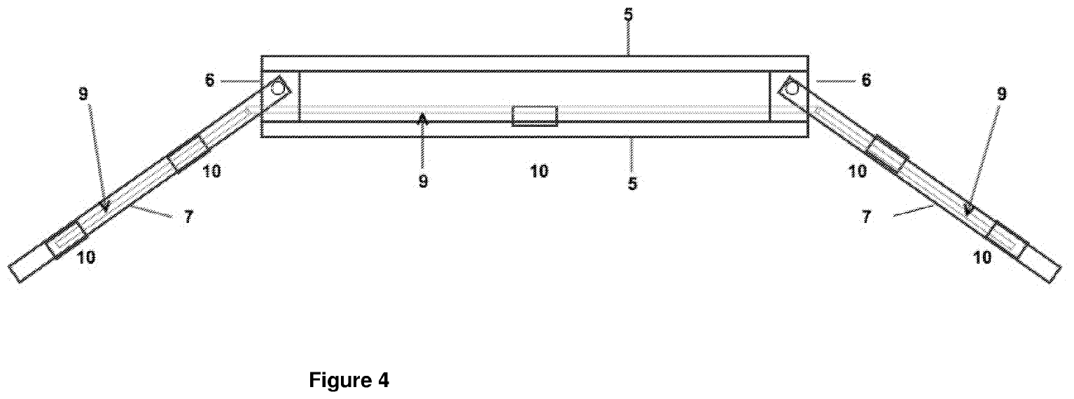

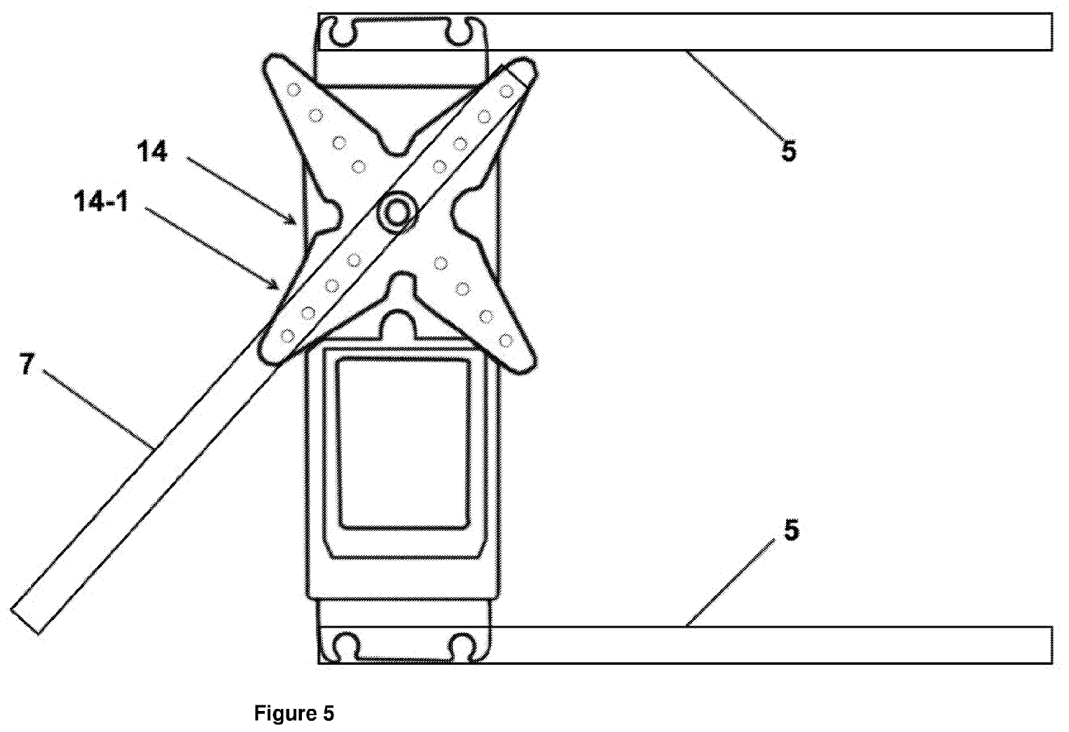

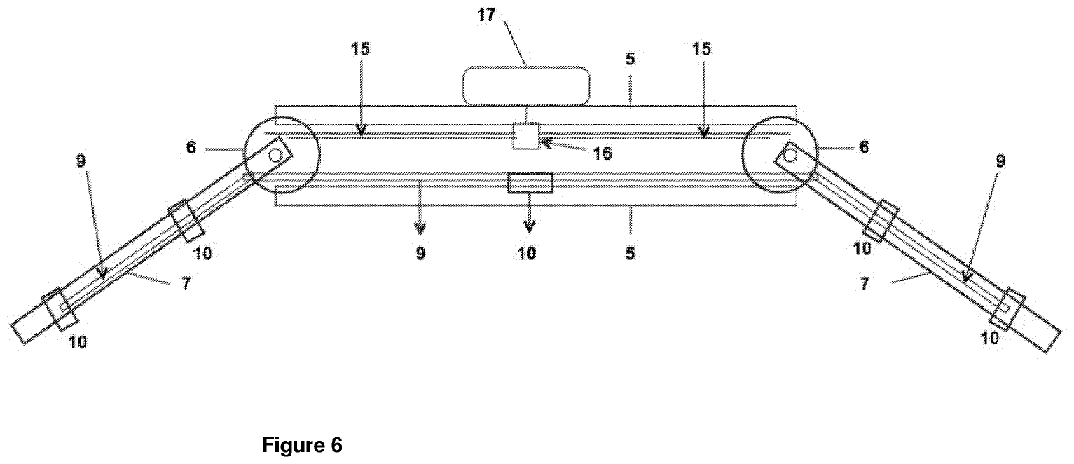

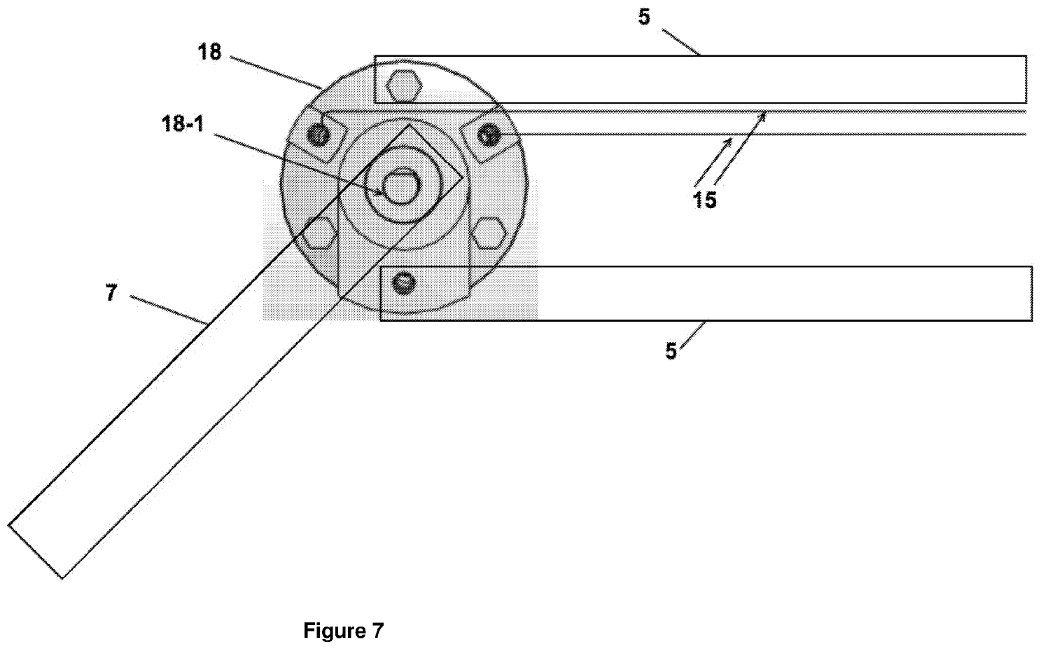

Number “8” in FIG. 1 marks a landing wheel attached to the adjustable arm marked with number “7.” This landing wheel helps the device and assembly achieve smooth landings, ensuring that no harm is caused to the spray system. The landing wheel is used in the preferred embodiment of the present disclosure, while other embodiments may use different landing stabilizers found in the prior art, such as landing skids. Number “8-1” indicates a hinge that can bend to the front from 0 to 90 degrees. This hinge serves to extend the adjustable arm during landing and ensures that the connected spray system lands unharmed. This landing stabilizing structure is described in further details in FIG. 3c.

Numbers “9” and “10” in FIG. 1 indicate the components of the spray sub-assembly. Number “9” marks the tube that transfers chemical from the storage tank to the spray nozzles, which are marked in number 10. These tubes flow parallel to the fixed and adjustable arms and can be adjustable in length depending on the number of spray nozzles, i.e. shorter if fewer nozzles and longer if more nozzles. In various embodiments of the present disclosure, the number of spray nozzles can be increased and decreased and are directionally oriented to target specific crop types. The nozzles are attached to both the tubes and to the adjustable arms. Rotating the adjustable arms re-orient the nozzles directionally. The tubes and nozzles are comprised of material commonly used and well-known in the prior art. In various embodiments of the present disclosure, the tubes may consist of silica gel, nylon pressure, or polyvinyl chloride tubes, and they may range from four to thirty millimeters in diameter and one to eight meters in length; the nozzles may consist of chemically resistant material such as ceramic, stainless steel, brass, polymer, plastic, and polypropylene, with a target-specific dispensing diameter between 0.2-1.5 meters.

FIG. 2 diagrams a frontal view of an embodiment of the angle-adjusting sub-assembly and the attached spray sub-assembly while the device is spraying pesticide, herbicide, bactericide, fungicide, or any hazardous chemical that can be sprayed onto targeted crops. Like FIG. 1, number “5” indicates the fixed arm, number “6” indicates the angle-adjusting component of the sub-assembly, number “7” indicates the adjustable arms, number “8” indicates the landing wheel, number “9” indicates the transfer tubes, and number “10” indicates the spray nozzles. The embodiment's dashed lines demonstrate how the angle-adjusting hinge and chain moves to rotate the adjustable arms across a 120-degree axis. The rotation of the adjustable arms directionally reorients the chemical tubes and nozzles to precisely target crops at different angle and to eliminate pests while reducing the disbursement of toxic chemical waste.

FIG. 3a specifically diagrams the angle-adjusting sub-assembly, the core component of each embodiment of the disclosure. The angle-adjusting sub-assembly is marked with number “6” in FIGS. 1-2, in detail. In FIG. 3a, number “11” indicates solid inner tubes plugged to both the fixed and adjustable arms, which, in conjunction with the hinge and chain, enable angular movement of the adjustable arms. Number “12” indicates hinges attached to the edges of each solid inner tubes, the fixed arm, and the adjustable arms. Number “13” indicates an adjustable piece and chain that extends and retracts, causing the tubes to rotate, which, in turn, cause the adjustable arms to rotate. The chain can be controlled manually, electronically, hydraulically, or through air pressure.

FIG. 3b is identical to FIG. 3a, except that it diagrams a three-dimensional, rather than a two-dimensional, detailed view of the angle-adjusting sub-assembly.

FIG. 3c diagrams a frontal view of the landing sub-assembly, which is a component of the present disclosure, as is described in Paragraph 0005, above. The landing sub-assembly includes hinges, indicated by number 8-1, that bend between 0 and 90 degrees and enable the adjustable arms to move forward upon the device's landing. Landing wheels, indicated in the figure with number 8, further assist with a smooth landing. This figure demonstrates how the lower half of the adjustable arms bend upon landing, ensuring no damage is caused to the device's spray system during its descent.

FIG. 4 diagrams a preferred embodiment of the full disclosure, including the angle-adjusting sub-assembly, the accompanying system and device, and the attached flying, aerial apparatus. In this preferred embodiment, the angle-adjusting sub-assembly is operated electronically with electric motors. A detailed view of this embodiment of the angle-adjusting sub-assembly is diagramed in FIG. 5.

FIG. 5 diagrams a two-dimensional view of the preferred embodiment of the angle-adjusting sub-assembly. In FIG. 5, number “14” indicates an electric servo motor attached to the fixed arms. Number “14-1” indicates a rotating pallet that is attached to the servo motor and causes movement of the adjustable arms, which in turn allows the arms to rotate between the horizontal position and 120 degrees downward from outside to inside from the horizontal position.

FIG. 6 diagrams an alternative embodiment of the full disclosure. Here, an angle-adjusting sub-assembly that is driven by air or hydraulic pressure (described in further detail in FIG. 7) replaces the manual adjusting sub-assembly used in other embodiments. In this embodiment, the chemical tubes indicated with number “9” are adjustable in length. This embodiment also includes new parts, such as air or hydraulic ducts for gas to come in and out of the angle-adjusting sub-assembly (indicated by number “15”), a valve (indicated by number “16”) to control the direction of airflow or liquid, thereby controlling the angles of the device's fixed and adjustable arms, and an air tank or hydraulic accumulator (indicated by number “17”) to store the air/liquid that flows through the valve and the ducts in order to adjust the angles.

FIG. 7 diagrams a detailed, two-dimensional, frontal view of the air-pressure-driven angle-adjusting sub-assembly. Number “18” in this figure indicates a pneumatic/hydraulic rotary actuator situated between the two fixed arms (each indicated by the number “5”). The adjustable arm, indicated in the figure by the number “7”, is attached to the rotary axis, which is indicated in the figure by number 18-1. Controlling the air/hydraulic pressure through the air/hydraulic ducts indicated by number “15” allows the adjustable arm to rotate at any angle between 0 and 120 degrees.

The above description of the disclosed embodiments is provided to enable any person skilled in the art to make or use the present disclosure. Various modifications to these embodiments will be readily apparent to those skilled in the art, and the generic principles described herein can be applied to other embodiments without departing from the spirit or scope of the present disclosure. Thus, it is to be understood that the description and drawings presented herein represent a presently preferred embodiment of the present disclosure and are therefore representative of the subject matter, which is broadly contemplated by the present disclosure. It is further understood that the scope of the present disclosure fully encompasses other embodiments that may become obvious to those skilled in the art.

### BRIEF DESCRIPTION OF THE DRAWINGS

The embodiments are illustrated by way of example and not limitation in the figures of the accompanying drawings in which like references indicate like elements.

FIG. 1 illustrates a diagram of the structural components used by the present disclosure, in accordance with an embodiment of the present disclosure.

FIG. 2 illustrates another diagram the structural components used by the present disclosure, in accordance with an embodiment of the present disclosure.

FIG. 3a illustrates a diagram of the structural components used by the present disclosure, in accordance with an embodiment of the present disclosure.

FIG. 3b illustrates a diagram of the structural components used by the present disclosure, in accordance with an embodiment of the present disclosure.

FIG. 3c illustrates a diagram of the structural components used by the present disclosure, in accordance with an embodiment of the present disclosure.

FIG. 4 illustrates a diagram of the structural components used by the present disclosure, in accordance with an embodiment of the present disclosure.

FIG. 5 illustrates a diagram of the structural components in accordance with an embodiment of the present disclosure.

FIG. 6 illustrates a diagram of the structural components by the present disclosure, in accordance with an embodiment of the present disclosure.

FIG. 7 illustrates a diagram showing the structural components used in accordance with an embodiment of the present disclosure.

What is claimed is:

1) An angle-adjusting sub-assembly that is part of or attached to an unmanned aerial vehicle and apparatus, for the targeted distribution of hazardous chemicals onto vegetation, and is comprised of:
a) one or more adjustable arms;
b) a chain-and-hinge, electric-motor, pneumatic rotary system, or hydraulic rotary system, which adjusts both the length and angle of the adjustable arms while the aerial vehicle and apparatus are airborne.

2) The angle-adjusting sub-assembly of claim 1, where the adjustable arms are composed of any combination of composite material, polymeric material, or light metal, including, but not limited to, carbon fiber, glass fiber, or aluminum alloy.

3) The angle-adjusting sub-assembly of claim 1, where the length of the adjustable arms changes between 60 and 300 centimeters while the unmanned aerial vehicle is airborne.

4) The angle-adjusting sub-assembly of claim 1, where the angle of the adjustable arms rotates between 0 and 120 degrees while the unmanned aerial vehicle and apparatus of claim 1 are airborne.

5) The angle-adjusting sub-assembly of claim 1, where the length and angle of the adjustable arms are changed using electronic motors, comprised of electric servo motors and rotating metal pallets, physically attached to the adjustable arms.

6) The electronic motors of claim 1 or 5, where the length and angle of the adjustable arms are changed using electronic motors physically attached to the adjustable arms.

7) The angle-adjusting sub-assembly of claim 1, where the adjustable arms that change in length and angle, while the unmanned aerial vehicle and apparatus of claim 1 is airborne, are used to precisely target pests, fungi, bacteria, or undesirable vegetation with hazardous chemicals.

8) The angle-adjusting sub-assembly of claim 1, for minimizing the spray radius generated when eliminating pests, bacteria, fungi, or undesirable vegetation.

9) The angle-adjusting sub-assembly of claim 1, for minimizing toxic exposure generated when eliminating pests, bacteria, fungi, or undesirable vegetation.

10) An unmanned aerial vehicle and apparatus, for the targeted distribution of hazardous chemicals onto vegetation, comprised of:
a) the angle-adjusting sub-assembly from claim 1;
b) a spray assembly;
c) a flying platform operated by batteries and propellers;
d) a storage tank containing pesticide, bactericide, herbicide, fungicide, or any hazardous chemical that can be sprayed on vegetation;
e) a supporting structure, and;
f) a landing sub-assembly

11) The unmanned aerial vehicle and apparatus of claim 10, where said storage tank is comprised of plastic, polyethylene, or aluminum alloy.

12) The unmanned aerial vehicle and apparatus of claim 10, where said storage tank holds a volume between five and thirty liters.

13) The unmanned aerial vehicle and apparatus of claim 10, where said spray assembly contains an electrically-driven pump used to transfer chemical from the storage tank to the nozzles of the spray assembly for distribution.

14) The unmanned aerial vehicle and apparatus of claim 10, where said spray assembly contains nozzles for distributing chemicals onto the vegetation and tubes connecting the nozzles with the storage tank of claims 12 and 13.

15) The spray assembly of claim 1 or 14, where the nozzles are comprised of ceramic, stainless steel, brass, polymer, plastic, or polypropylene.

16) The spray assembly of claim 1 or 14, where the nozzles dispense chemicals onto vegetation at a rate between 0.1-5 liters per minute.

17) The spray assembly of claim 1 or 14, where the number of nozzles included can be adjusted according to need.

18) The spray assembly of claim 1 or 14, where the nozzles are attached to the adjustable arms from the angle-adjusting sub-assembly of the unmanned aerial vehicle and apparatus of claim 1 or 10.

19) The spray assembly of claim 1 or 14, where the nozzles are oriented directionally using the adjustable arms in the angle-adjusting sub-assembly of the unmanned aerial vehicle and apparatus of claim 1 or 10.

20) The spray assembly of claim 1 or 14, where the tubes are comprised of silica gel, nylon pressure, or polyvinyl chloride tubes.

21) The spray assembly of claim 1 or 14, where the tubes are between four to thirty millimeters in diameter.

22) The spray assembly of claim 1 or 14, where the tubes are adjustable in length between one to eight meters.

23) The spray assembly of claim 1 or 14, where the tubes are placed parallel to the fixed and adjustable arms in the angle-adjusting sub-assembly of the unmanned aerial vehicle and apparatus of claim 1 or 10.

24) The unmanned aerial vehicle and apparatus of claim 1 or 10, where the supporting structure consists of two or more legs, comprised of one or more metal alloys, and one or more fixed arms, between 60 and 300 centimeters in length, that protrudes from the lower half of the legs beneath the placement of the spray assembly of claim 1 or 14.

25) The supporting structure of claim 10, or 24, where the legs are physically attached to the flying platform, the storage tank, and the spray assembly, and the fixed arms are physically attached to the adjustable arms from the angle-adjusting sub-assembly of claim 1.

26) The supporting structure of claim 10 or 24, where the fixed arms are comprised of any combination of composite material, polymeric material, or light metal.

27) The supporting structure of claim 10 or 24, where the fixed arms are comprised of carbon fiber, glass fiber, or aluminum alloy.

28) The angle-adjusting sub-assembly of claim 1, where the adjustable arms are attached to the nozzles of the spray assembly of claim 10 or 14, and, by changing in length and angle while the unmanned aerial vehicle and apparatus of claim 1 or 10 are airborne, directionally orient the nozzles for the precise targeting of pests, bacteria, or fungus attacking vegetation.

29) angle-adjusting sub-assembly of claim 1, where the length and angle of the adjustable arms are changed using an attached chain-and-hinge system consisting of:
a) solid inner tubes attached to both the fixed arms from the supporting structure of claim 10 or 24, and to the adjustable arms of the angle-adjusting sub-assembly;
b) a hinge attached to the edges of said solid inner tubes, said fixed arms, and said adjustable arms;
c) an extendable chain that attaches to the hinge, the inner tubes, the fixed arms, and the adjustable arms, and;
d) one or more manual, electric, hydraulic or air pressure-based controls causing the chain to extend and retract.

30) The chain-and-hinge system of claim 1 or 29, where said system causes the length and angle of the adjustable arms to change while the unmanned aerial vehicle and apparatus of claim 1 or 10 is airborne.

31) The angle-adjusting sub-assembly of claim 1, where the solid tubes are adjustable in length and the length and angle of the adjustable arms are changed using a hydraulic rotary actuator situated between the fixed arms of the supporting structure of claim 10 or 24.

32) The angle-adjusting sub-assembly of claim 1, where the solid tubes are adjustable in length and the length and angle of the adjustable arms are changed using a pneumatic rotary actuator structure situated between the fixed arms of the supporting structure of claim 10 or 24.

33) The angle-adjusting sub-assembly of claim 1 or 32, where the pneumatic rotary actuator consists of a pneumatic rotary actuator, air ducts allowing gas to come in and out of the angle-adjusting sub-assembly, and a valve to control the direction of the airflow.

34) The angle-adjusting sub-assembly of claim 1, where hinges in the landing sub-assembly of claim 1 cause the adjustable arms of the sub-assembly to retract and bend inward at an acute angle when the unmanned aerial vehicle and apparatus of claim 1 is landing.

35) The angle-adjusting sub-assembly of claim 1, where the retraction and inward, acute bending of the adjustable arms protects the spray assembly of claim 10 or 14 when the unmanned aerial vehicle and apparatus of claim 1 or 10 is landing.

36) The unmanned aerial vehicle and apparatus of claim 1 or 10, where the flying platform is attached to the top of the storage tank and supporting structure.

37) The unmanned aerial vehicle and apparatus of claim 1 or 10, where the landing sub-assembly is comprised of hinges and one or more landing wheels, plates, or bumpers that protect the aerial vehicle and apparatus during landing.

38) The landing sub-assembly of claim 10 or 37, where the bending of the hinges at an angle between 0 and 90 degrees enables the retraction and inward, acute bending of the adjustable arms of the angle-adjusting sub-assembly.

39) The landing sub-assembly of claim 10 or 37, where both the hinges and the landing wheels, plates or bumpers are attached to the adjustable arms of the angle-adjusting sub-assembly.
